(19) United States
(12) Patent Application Publication
(10) Pub. No.: US 2025/0178692 A1
(43) Pub. Date: Jun. 5, 2025

(54) DRIVE UNIT FOR ELECTRICALLY ASSISTED BICYCLE AND ELECTRICALLY ASSISTED BICYCLE

(71) Applicants: YAMAHA HATSUDOKI KABUSHIKI KAISHA, Iwata-shi (JP); UCHIYAMA MANUFACTURING CORP., Okayama-shi (JP)

(72) Inventors: Yuta AKAZAWA, Shizuoka (JP); Kenta EMI, Okayama (JP)

(21) Appl. No.: 18/962,926

(22) Filed: Nov. 27, 2024

(30) Foreign Application Priority Data
Nov. 30, 2023 (JP) 2023-203276

(51) Int. Cl. B62M 6/55

(52) U.S. Cl. CPC B62M 6/55

(57) ABSTRACT

A drive unit for an electrically assisted bicycle includes a housing and a rotatable shaft made of metal materials different from each other, an outer circumferential portion of a dust seal in contact with an inner circumferential portion of an opening of the housing that allows the rotatable shaft to extend therethrough, and an outer end, in a rotation axis direction of the rotatable shaft, of the inner circumferential portion of the opening of the housing including a chamfered portion having a diameter increasing toward an outside of the opening. The dust seal includes a first lip covering the chamfered portion, and the dust seal does not protrude outward, in the rotation axis direction, of an outermost portion of the opening in the rotation axis direction.

### CROSS REFERENCE TO RELATED APPLICATIONS

This application claims the benefit of priority to Japanese Patent Application No. 2023-203276 filed on Nov. 30, 2023. The entire contents of this application are hereby incorporated herein by reference.

### BACKGROUND OF THE INVENTION

### 1. Field of the Invention

The present invention relates to drive units for electrically assisted bicycles, and electrically assisted bicycles.

### 2. Description of the Related Art

Bicycles are widely used by a variety of people regardless of the age or gender as easy-to-use means of transportation. Recently, electrically assisted bicycles, by which power of users performing pedaling is assisted by electric motors, are increasingly widespread (see, for example, Japanese Laid-Open Patent Publication No. 2007-230411).

Such an electric motor is supplied with electric power from a battery mounted on a vehicle, i.e., the electrically assisted bicycle and thus generates drive power. The electrically assisted bicycle causes the electric motor to generate drive power corresponding to the power of a human body, specifically, the power provided by a user to the pedals, and thus alleviates the load imposed on the user while, for example, traveling on a slope or traveling with a cargo.

### SUMMARY OF THE INVENTION

A drive unit of an electrically assisted bicycle includes a housing accommodating an electric motor, and a rotatable shaft partially exposed to an outside of the housing. For example, a crankarm is attached to the rotatable shaft.

In the case where the housing and the rotatable shaft include metal materials different from each other, there is a problem that when water accumulates between an opening of the housing and the rotatable shaft, electrolytic corrosion (galvanic corrosion) easily occurs.

Example embodiments of the present invention reduce or prevent the electrolytic corrosion of drive units of electrically assisted bicycles as described below.

According to an example embodiment of the present invention, a drive unit for an electrically assisted bicycle includes an electric motor, a housing to accommodate the electric motor, a rotatable shaft rotatably supported by the housing and partially exposed to an outside of the housing, and a ring-shaped dust seal between the rotatable shaft and the housing to reduce or prevent entrance of dust from the outside the housing into an inside of the housing, wherein the housing and the rotatable shaft include metal materials different from each other, an inner circumferential portion of the dust seal is in slidable contact with the rotatable shaft, an outer circumferential portion of the dust seal is in contact with an inner circumferential portion of an opening of the housing to allow the rotatable shaft to extend therethrough, an outer end, in a rotation axis direction of the rotatable shaft, of the inner circumferential portion of the opening of the housing includes a chamfered portion having a diameter increasing toward an outside of the opening, the dust seal includes a first lip covering the chamfered portion, and the dust seal does not protrude outward, in the rotation axis direction, of an outermost portion of the opening in the rotation axis direction.

In the case where the housing and the rotatable shaft include metal materials different from each other, when water accumulates between the opening of the housing and the rotatable shaft, electrolytic corrosion (galvanic corrosion) easily occurs. The electrolytic corrosion may be reduced to some extent by applying a paint to the opening. However, there are cases where the paint is not applied to the opening in a satisfactory manner. In the case where, for example, the protrusion provided at the opening is thin, the paint is not applied to the protrusion in a satisfactory manner. According to an example embodiment of the present invention, the dust seal includes the first lip covering the chamfered portion of the opening. The first lip covers the chamfered portion so that the electrolytic corrosion may be reduced or prevented even when the paint is not applied to the opening in a satisfactory manner.

According to an example embodiment of the present invention, the dust seal does not protrude outward, in the rotation axis direction, of the outermost portion of the opening. With this arrangement, the size of the drive unit in the width direction may be decreased.

The crankarms may be attached to the rotatable shaft. If the dust seal protrudes outward of the opening of the housing, the dust seal may interfere with the crankarms or the like. Since the dust seal does not protrude outward of the opening in this example embodiment, the interference of the dust seal with the crankarms is reduced or prevented.

In the drive unit above, the first lip of the dust seal extends away from the rotatable shaft and outward in the rotation axis direction.

With this arrangement, the chamfered portion of the opening may be covered appropriately.

In the drive unit above, the inner circumferential portion of the opening includes a groove extending in a circumferential direction of the opening, and the outer circumferential portion of the dust seal includes a second lip fitted into the groove.

Since the second lip of the dust seal is fitted into the groove of the opening, the dust seal may be secured to the housing.

In the drive unit above, the opening includes a protrusion defining an outer wall of the groove in the rotation axis direction, and the chamfered portion is located at the protrusion.

Even when paint is not applied to the opening in a satisfactory manner, the first lip covers the chamfered portion and thus the electrolytic corrosion is reduced or prevented.

In the drive unit above, the second lip of the dust seal is snap-fit into the groove.

The dust seal may be secured to the housing by snap-fit. In addition, the entrance of water and dust into the inside of the housing is reduced or prevented more effectively.

In the drive unit above, the first lip and the second lip of the dust seal secure the protrusion therebetween by an elastic force thereof.

With this arrangement, a gap is unlikely between the first lip and the chamfered portion, and thus the electrolytic corrosion is reduced or prevented more effectively. In addition, the entrance of water and dust into the inside of the housing is reduced or prevented more effectively.

In the drive unit above, the dust seal is press-fit into the opening.

The dust seal is press-fit to the opening, and therefore, may be secured to the housing.

In the drive unit above, the inner circumferential portion of the dust seal includes a seal lip in slidable contact with the rotatable shaft.

With this arrangement, the flow of oil from the inside to the outside of the housing and the entrance of water and dust from the outside into the inside of the housing is reduced or prevented.

In the drive unit above, wherein the inner circumferential portion of the dust seal further includes a dust lip in slidable contact with the rotatable shaft and located outward of the seal lip in the rotation axis direction.

With this arrangement, the entrance of dust from the outside into the inside of the housing is reduced or prevented.

In the drive unit above, the housing includes a metal material including magnesium as a main component.

With this arrangement, the weight of the drive unit may be decreased.

In the drive unit above, the rotatable shaft includes a metal material including iron as a main component.

With this arrangement, a level of rigidity and strength that is required of the rotatable shaft may be realized at low cost.

According to an example embodiment of the present invention, an electrically assisted bicycle includes the drive unit according to any of the above-described example embodiments.

With this arrangement, an electrically assisted bicycle including a drive unit that is compact and highly resistant to water may be realized.

In the case where the housing and the rotatable shaft of the drive unit include metal materials different from each other, when water accumulates between the opening of the housing and the rotatable shaft, electrolytic corrosion (galvanic corrosion) easily occurs. The electrolytic corrosion may be reduced to some extent by a paint applied to the opening. However, there are cases where the paint is not applied to the opening in a satisfactory manner. In the case where, for example, a protrusion provided at the opening is thin, the paint is not applied to the protrusion in a satisfactory manner. According to an example embodiment of the present invention, the dust seal includes the first lip covering the chamfered portion of the opening. The first lip covers the chamfered portion so that the electrolytic corrosion is reduced or prevented even when the paint is not applied to the opening in a satisfactory manner.

According to an example embodiment of the present invention, the dust seal does not protrude outward, in the rotation axis direction, of the outermost portion of the opening. With this arrangement, the size of the drive unit in the width direction may be decreased.

The crankarms may be attached to the rotatable shaft. If the dust seal protrudes outward of the opening of the housing, the dust seal may interfere with the crankarms or the like. Since the dust seal does not protrude outward of the opening in this example embodiment, the interference of the dust seal with the crankarms is reduced or prevented.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a right side view showing an electrically assisted bicycle 1 according to an example embodiment of the present invention.

FIG. 2 is a cross-sectional view showing an example of an internal configuration of a drive unit 20 according to an example embodiment of the present invention.

FIG. 3 is a cross-sectional view showing a portion of a housing 21 according to an example embodiment of the present invention.

FIG. 4 is a cross-sectional view showing an opening 261 of the housing 21 and a rotatable shaft 30 extending through the opening 261 according to an example embodiment of the present invention.

FIG. 5 is a perspective view showing a dust seal 60 cut along a plane parallel to a rotation axis direction D1 according to an example embodiment of the present invention.

FIG. 6 is a partial enlarged cross-sectional view of the drive unit 20 according to an example embodiment of the present invention.

FIG. 7 is a partial enlarged cross-sectional view of the drive unit 20 according to an example embodiment of the present invention.

FIG. 8 is a cross-sectional view showing the positional relationship between the opening 261 of the housing 21 and the dust seal 60 in the rotation axis direction D1 according to an example embodiment of the present invention.

FIG. 9 is a cross-sectional view showing the dust seal 60 in a state of being secured to an inner circumferential portion 262 of the opening 261 by press-fit according to an example embodiment of the present invention.

### DETAILED DESCRIPTION OF THE EXAMPLE EMBODIMENTS

Hereinafter, example embodiments of the present invention will be described with reference to the drawings. In the description of the example embodiments, like elements will bear like reference signs, and overlapping descriptions will be omitted. In the drawings, letters F, Re, L, R, U and D respectively indicate front, rear, left, right, up and down. The “front-rear”, “left-right” and “up-down” directions regarding an electrically assisted bicycle respectively indicate front-rear, left-right and up-down directions for a user sitting on a seat (saddle) of the electrically assisted bicycle while facing a handle. The following example embodiments are merely illustrative, and do not limit the present invention in any way.

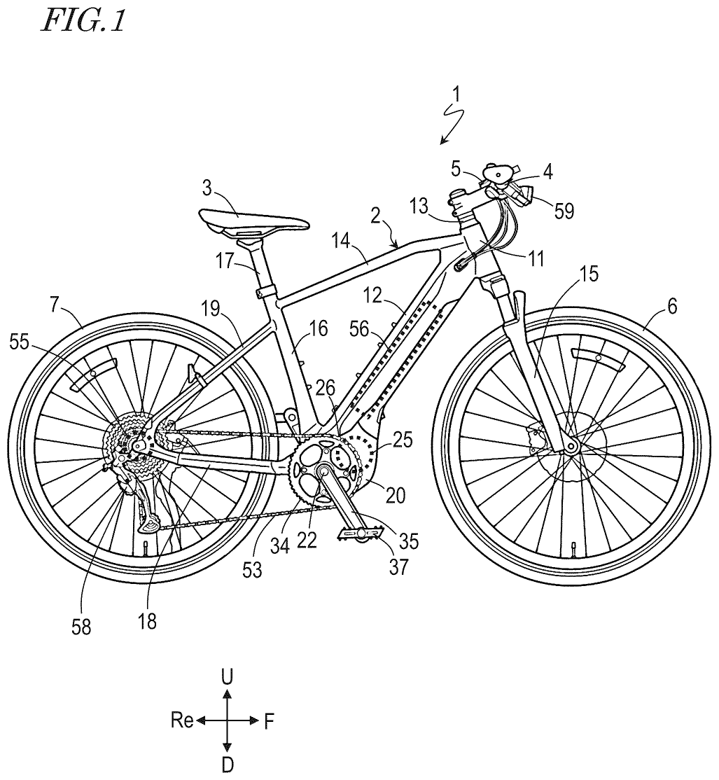

FIG. 1 is a right side view of an electrically assisted bicycle 1 according to an example embodiment of the present invention.

The electrically assisted bicycle 1 includes a body frame 2 extending in a front-rear direction. The body frame 2 includes a head pipe 11, a down tube 12, a top tube 14, a seat tube 16, a chain stay 18, a seat stay 19, and a bracket 26. The head pipe 11 is located at a front end of the body frame 2. A handle column 13 is rotatably inserted into the head pipe 11. A handle 4 is secured to the handle column 13. A meter unit 5 displaying various types of information on the electrically assisted bicycle 1 is provided on the handle 4. A head lamp 59 is provided to the front of the handle 4.

A front fork 15 is secured to a bottom end of the handle column 13. A bottom end of the front fork 15 supports a front wheel 6, which is a steering wheel, such that the front wheel 6 is rotatable.

The down tube 12 extends obliquely rearward and downward from the head pipe 11. The seat tube 16 extends upward from a rear end of the down tube 12. The chain stay 18 extends rearward from a bottom end of the seat tube 16. The bracket 26 connects the rear end of the down tube 12, the bottom end of the seat tube 16 and a front end of the chain stay 18 to each other. The top tube 14 connects a top portion of the head pipe 11 and a top portion of the seat tube 16 to each other. A seat post 17 is inserted into the seat tube 16. The saddle 3, on which the user may sit, is provided at a top end of the seat post 17.

A rear end of the chain stay 18 supports a rear wheel 7, which is a driving wheel, such that the rear wheel 7 is rotatable. The seat stay 19 extends obliquely rearward and downward from the top portion of the seat tube 16. A bottom end of the seat stay 19 is connected with the rear end of the chain stay 18. A transmission 58 to change the transmission ratio is provided at the rear end of the chain stay 18. The transmission 58 may be provided in the vicinity of a pedal crankshaft 22. A speed sensor 55, which detects the rotation rate of the rear wheel 7, is provided on a rear portion of the chain stay 18. The speed sensor 55 may be provided on a bottom portion of the front fork 15 to detect the rotation rate of the front wheel 6.

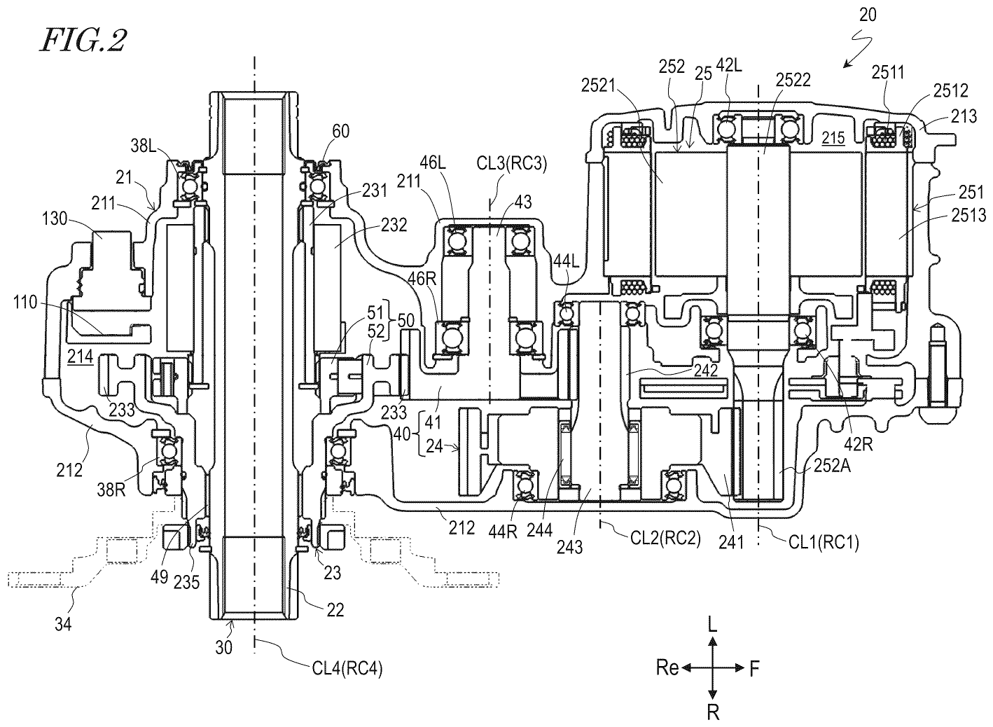

A drive unit 20 is provided on the bracket 26 located in the vicinity of a location, in the body frame 2, that is the center of the vehicle (i.e., the electrically assisted bicycle 1). A housing 21 (FIG. 2) of the drive unit 20 accommodates an electric motor 25, an MCU (motor control unit), a decelerator 24 (FIG. 2), and the like. The pedal crankshaft 22 is supported by extending through the drive unit 20 in a left-right direction. Crankarms 35 are respectively provided at both of two ends of the pedal crankshaft 22. Pedals 37 are rotatably provided respectively at tips of the crankarms 35.

A battery unit 56 to supply electric power to the drive unit 20 or the like is mounted on the down tube 12. In the example shown in FIG. 1, the battery unit 56 is provided inside the down tube 12. The down tube 12 may be hollow. At least a portion of the down tube 12 may have a U-shaped cross-section, and the down tube 12 may be provided with a cover covering the U-shaped portion.

The battery unit 56 may be located on an outer surface of the down tube 12. The battery unit 56 may be mounted on the bracket 26 or the seat tube 16. The battery unit 56 may be detachable from the electrically assisted bicycle 1.

The battery unit 56 includes a battery and a BMS (battery management system). The battery is a rechargeable battery. The BMS controls charge/discharge of the battery and monitors an output current, a battery remaining capacity and the like of the battery.

The MCU of the drive unit 20 controls operations of the electric motor 25, and also controls operations of various components of the electrically assisted bicycle 1. The MCU includes a semiconductor integrated circuit such as a processor or the like and a motor driving circuit. A rotation of the pedal crankshaft 22 generated by the user stepping on the pedals 37 is conveyed to the rear wheel 7 via a driving sprocket 34 and a chain 53. The MCU controls the electric motor 25 to generate a driving assisting output corresponding to a rotation output of the pedal crankshaft 22 generated by the user stepping on the pedals 37. Assist power generated by the electric motor 25 is conveyed to the rear wheel 7 via the driving sprocket 34 and the chain 53. Instead of the chain 53, a belt, a shaft or the like may be used.

With respect to FIG. 2, an example of a configuration of the drive unit 20 will be described. FIG. 2 is a cross-sectional view showing an example of an internal configuration of the drive unit 20.

As shown in FIG. 2, the drive unit 20 includes the housing 21, a rotatable shaft 30, a conveyance mechanism 40, and the electric motor 25.

First, the configuration of the housing 21 according to this example embodiment will be described.

The housing 21 is secured to the bracket 26 (see FIG. 1) by a plurality of fasteners. The housing 21 includes a first case 211, a second case 212, and a cover 213. The housing 21 is made of, for example, a metal material including magnesium as a main component (magnesium alloy). Use of a metal material including magnesium as a main component may decrease the weight of the drive unit 20.

The first case 211 is stacked on the second case 212 in the left-right direction, more specifically, from the left. The first case 211 and the second case 212 are secured to each other by a plurality of fasteners. As a result, a space 214 is provided between the first case 211 and the second case 212.

The cover 213 is stacked on the first case 211 in the left-right direction, more specifically, from the left. The cover 213 and the first case 211 are secured to each other by a plurality of fasteners. As a result, a space 215 covered with the cover 213 is provided to the left of the first case 211. The electric motor 25 is accommodated in the space 215.

Now, a configuration of the rotatable shaft 30 according to this example embodiment will be described. The rotatable shaft 30 includes the pedal crankshaft 22 and a rotation shaft 23.

The rotatable shaft 30 extends through the housing 21 in the left-right direction of the vehicle, and is rotatably supported by the housing 21.

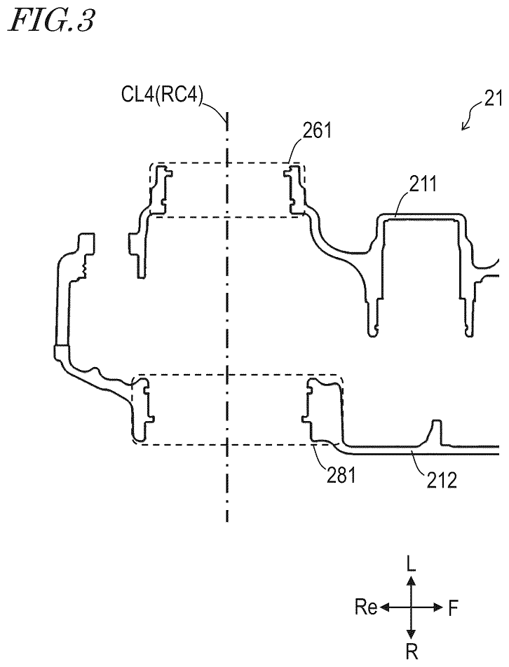

FIG. 3 is a cross-sectional view showing a portion of the housing 21. An opening 261 is provided in the first case 211 of the housing 21. An opening 281 is provided in the second case 212. The opening 261 and the opening 281 are each cylindrical. The rotatable shaft 30 extends through the opening 261 and the opening 281, and thus a portion of the rotatable shaft 30 is exposed to an outside of the housing 21.

A central axis line CL4 of the pedal crankshaft 22 extends in the left-right direction. As seen in an axial direction (thrust direction) of the pedal crankshaft 22, the central axis line CL4 is a rotation central axis RC4 (fourth central axis) of the pedal crankshaft 22. The pedal crankshaft 22 rotates around the central axis line CL4 with respect to the housing 21. The rotation central axis RC4 is the rotation axis of the rotatable shaft 30.

The rotatable shaft 30 including the pedal crankshaft 22 extends through the housing 21 along the fourth central axis RC4, and is supported by the housing 21 so as to be rotatable around the fourth central axis RC4. The pedal crankshaft 22 is rotatably supported by a pair of bearings 38L and 38R inside the housing 21. The bearing 38L is located on the left side in the axial direction and is secured to the first case 211. The bearing 38R is located on the right side in the axial direction, and is secured to the second case 212.

The pedal crankshaft 22 extends through the rotation shaft 23. The rotation shaft 23 is accommodated in the housing 21. The rotation shaft 23 will be described in detail below. The pair of, more specifically, left and right, crankarms 35 (FIG. 1) are attached to the pedal crankshaft 22. The pedals 37 (FIG. 1) are respectively attached to the crankarms 35.

The pedal crankshaft 22 includes a metal material including iron as a main component, for example, carbon steel, alloy steel or the like. Use of such a metal material including iron as a main component may realize a level of rigidity and strength that is required of the pedal crankshaft 22 at a low cost.

Now, a configuration of the electric motor 25 and the conveyance mechanism 40 according to this example embodiment will be described.

The electric motor 25 is accommodated in the housing 21 and is secured to the housing 21. The electric motor 25 generates drive power to assist the electrically assisted bicycle 1 run. The electric motor 25 includes a stator 251 and a rotor 252.

The stator 251 includes a plurality of bobbins 2512, around each of which a coil 2511 is wound. An iron core 2513 is inserted into each of the bobbins 2512. The stator 251 is located in the space 215. In this state, the stator 251 is secured to the first case 211.

The rotor 252 is located inward of the stator 251. A central axis line CL1 of the rotor 252 is parallel to the central axis line CL4 of the pedal crankshaft 22. That is, the rotor 252 is located to be parallel to the pedal crankshaft 22. As seen in the axial direction of the pedal crankshaft 22, the central axis line CL1 is a rotation central axis RC1 (first central axis) of the rotor 252.

The rotor 252 includes a rotor main body 2521 and an output shaft 2522. An outer circumferential surface of the rotor main body 2521 is magnetized with N poles and S poles alternately.

The output shaft 2522 extends through the rotor main body 2521. The output shaft 2522 is secured to the rotor main body 2521. That is, the output shaft 2522 is rotated together with the rotor main body 2521.

The output shaft 2522 is supported by the housing 21 so as to be rotatable around the first central axis RC1 inside the housing 21. The output shaft 2522 is supported by two bearings 42L and 42R so as to be rotatable around the central axis line CL1 with respect to the housing 21. The bearing 42L is secured to the cover 213. The bearing 42R is located to the right of the rotator main body 2521, and is secured to the first case 211. The output shaft 2522 extends through the first case 211. An output gear 252A is provided in a right portion of the output shaft 2522. The output gear 252A is, for example, a helical gear.

The conveyance mechanism 40 is accommodated in the housing 21. Specifically, the conveyance mechanism 40 is located in the space 214. The conveyance mechanism 40 includes the decelerator 24, an idle gear 41, and a rotation shaft 43. The conveyance mechanism 40 conveys a torque of the electric motor 25 to the rotation shaft 23.

The decelerator 24 is rotatably supported by the housing 21, and increases the torque of the output gear 252A of the electric motor 25. The decelerator 24 includes a first conveyance gear 241, a second conveyance gear 242, and a conveyance shaft 243. A central axis line CL2 of the conveyance shaft 243 is parallel to the central axis line CL4 of the pedal crankshaft 22. That is, the conveyance shaft 243 extends parallel to the central axis line CL4 of the pedal crankshaft 22. As seen in the axial direction of the conveyance shaft 243, that is, the axial direction of the pedal crankshaft 22, the central axis line CL2 is a rotation central axis RC2 (second central axis) of the conveyancer shaft 243. The decelerator 24 is supported by the housing 21 so as to be rotatable around the second central axis RC2 inside the housing 21.

The first conveyance gear 241 is located on a right portion, in the axial direction, of the conveyance shaft 243. A left portion of the conveyance shaft 243 is rotatably supported by the bearing 44L. The first conveyance gear 241 located on the right portion of the conveyance shaft 243 is rotatably supported by the bearing 44R. The conveyance shaft 243 and the first conveyance gear 241 are supported by the two bearings 44L and 44R so as to be rotatable around the central axis line CL2. The bearing 44L is secured to the first case 211. The bearing 44R is secured to the second case 212.

The first conveyance gear 241 is geared with the output gear 252A of the electric motor 25. With this arrangement, the drive power generated by the electric motor 25 is conveyed from the output gear 252A to the first conveyance gear 241.

A one-way clutch 244 is located between the first conveyance gear 241 and the conveyance shaft 243. The one-way clutch 244 couples the conveyance shaft 243 and the first conveyance gear 241 to each other. The one-way clutch 244 restricts the first conveyance gear 241 to rotate in one direction with respect to the conveyance shaft 243. A rotation force of the output gear 252A in a direction in which the rear wheel 7 (see FIG. 1) of the electrically assisted bicycle 1 is rotated forward is conveyed to the conveyance shaft 243 via the first conveyance gear 241, whereas a rotation force of the output gear 252A in a direction in which the rear wheel 7 is rotated rearward is not conveyed to the conveyance shaft 243. The one-way clutch 244 prevents the rotation force of a forward rotation of the pedal crankshaft 22 generated by the human power of the rider (i.e., the user) from being conveyed to the electric motor 25.

The first conveyance gear 241 has a diameter larger than that of the output gear 252A of the electric motor 25, and has a larger number of teeth than the output gear 252A does. That is, the first conveyance gear 241 is decelerated more than the output gear 252A.

The second conveyance gear 242 is made of a metal material (e.g., iron). The second conveyance gear 242 is located on the conveyance shaft 243. The second conveyance gear 242 is located at a position different from that of the first conveyance gear 241 in the axial direction of the conveyance shaft 243. The second conveyance gear 242 has a diameter smaller than that of the first conveyance gear 241, and has a fewer number of teeth than the first conveyance gear 241 does. The conveyance shaft 243 and the second conveyance gear 242 are integral with each other in this example embodiment, but are not limited thereto. The second conveyance gear 242 may be secured to the conveyance shaft 243 by serration coupling (or press-fit). The second conveyance gear 242 is rotated together with the conveyance shaft 243. The conveyance shaft 243 conveys the rotation of the first conveyance gear 241 to the second conveyance gear 242.

The idle gear 41 is made of a metal material (e.g., iron). The idle gear 41 is located on the conveyance shaft 243. The idle gear 41 is secured to the rotation shaft 43 by, for example, a fastener, but is not limited thereto. The idle gear 41 may be secured to the conveyance shaft 243 by serration coupling (or press-fit). The idle gear 41 and the rotation shaft 43 may be integral with each other. The idle gear 41 is rotated together with the conveyance shaft 243.

A central axis line CL3 of the rotation shaft 43 is parallel to the central axis line CL4 of the pedal crankshaft 22. That is, the rotation shaft 43 extends parallel to the central axis line CL4 of the pedal crankshaft 22. As seen in the axial direction of the rotation shaft 43, that is, the axial direction of the pedal crankshaft 22, the central axis line CL3 is a rotation central axis RC3 (third central axis) of the rotation shaft 43. The idle gear 41 secured to the rotation shaft 43 is supported by the housing 21 so as to be rotatable around the third central axis RC3 inside the housing 21.

The rotation shaft 43 is supported by two bearings 46L and 46R so as to be rotatable around the central axis line CL3. The bearings 46L and 46R are secured to the first case 211. The idle gear 41 is located closer to the bearing 46R than to the bearing 46L in the axial direction of the rotation shaft 43. The idle gear 41 is geared with the second conveyance gear 242 of the decelerator 24. With this arrangement, the output torque of the electric motor 25 increased by the decelerator 24 is conveyed to the idle gear 41.

Now, a configuration of the pedal crankshaft 22 and the vicinity thereof will be described.

The rotation shaft 23 is coaxial with the pedal crankshaft 22, and is rotatable together with the pedal crankshaft 22. The rotation shaft 23 includes a coupling shaft 231 and a one-way clutch 50.

The coupling shaft 231 is cylindrical. The pedal crankshaft 22 is inserted into the coupling shaft 231. The coupling shaft 231 is coaxial with the pedal crankshaft 22.

A left end of the coupling shaft 231 is coupled with the pedal crankshaft 22 by serration coupling or the like. As a result, regardless of whether the pedal crankshaft 22 is rotated forward or rearward, the coupling shaft 231 is rotated together with the pedal crankshaft 22.

A torque detector 232 is located around the coupling shaft 231. The torque detector 232 is supported by the coupling shaft 231, and is non-rotatable with respect to the first case 211. The torque detector 232 detects a torque to the coupling shaft 231 when the rider performs pedaling. The torque detector 232 is, for example, a torque sensor of a magnetostriction system. The torque detector 232 outputs a signal corresponding to the detected torque to the MCU mounted on a circuit substrate 110. The MCU refers to the torque detected by the torque detector 232 to determine the state of the pedaling performed by the rider and thus controls the electric motor 25. An external connection connector 130 electrically connects the drive unit 20 and an external device (e.g., the battery unit 56, the meter unit 5 or the like) to each other.

The one-way clutch 50 is located to the right of the torque detector 232 in the axial direction of the pedal crankshaft 22. The one-way clutch 50 is provided on the pedal crankshaft 22 via the coupling shaft 231. The one-way clutch 50 is coaxial with the pedal crankshaft 22. The one-way clutch 50 includes an inner member 51 and an outer member 52.

The inner member 51 of the one-way clutch 50 is cylindrical. A right portion of the coupling shaft 231 is inserted into the inner member 51. The inner member 51 is coaxial with the coupling shaft 231. In this state, the right portion of the coupling shaft 231 is coupled with the inner member 51 by serration coupling or the like. As a result, regardless of whether the coupling shaft 231 is rotated forward or rearward, the inner member 51 is rotated together with the coupling shaft 231. That is, regardless of whether the pedal crankshaft 22 is rotated forward or rearward, the inner member 51 is rotated together with the pedal crankshaft 22. The coupling shaft 231 and the inner member 51 act together as a crank rotation input shaft integrally rotatable with the pedal crankshaft 22.

The outer member 52 of the one-way clutch 50 is cylindrical. The pedal crankshaft 22 is inserted into the outer member 52. A plain bearing 49 is located between the outer member 52 and the pedal crankshaft 22. With this arrangement, the outer member 52 is coaxial with the pedal crankshaft 22 and is rotatable.

A latchet mechanism as a one-way clutch mechanism is provided between the outer member 52 and the inner member 51. With this arrangement, the rotation force in the forward rotation direction of the inner member 51 is conveyed to the outer member 52, whereas the rotation force in the rearward rotation direction of the inner member 51 is not conveyed to the outer member 52. The rotation force in the forward rotation direction of the outer member 52 that is generated by the rotation of the electric motor 25 is not conveyed to the inner member 51.

The outer member 52 is supported by the bearing 38R so as to be rotatable around the central axis line CL4 of the pedal crankshaft 22 with respect to the housing 21. The outer member 52 extends through the second case 212. A portion of the outer member 52 that is located outward of (to the right of) the housing 21 has the driving sprocket 34 attached thereto.

The outer member 52 includes a driven gear 233. The driven gear 233 is provided on the pedal crankshaft 22 via the one-way clutch 50 and the coupling shaft 231. The driven gear 233 is geared with the idler gear 41. The driven gear 233 has a diameter larger than that of each of the second conveyance gear 242 and the idle gear 41, and has a larger number of teeth than each of the second conveyance gear 242 and the idle gear 241 does. That is, the rotation rate of the driven gear 233 is lower than the rotation rate of each of the second conveyance gear 242 and the idle gear 41. The idle gear 41 is geared with each of the second conveyance gear 242 and the driven gear 233 so that the output torque of the electric motor 25 increased by the decelerator 24 may be conveyed to the driven gear 233 via the single idle gear 41.

The outer member 52 conveys a resultant force of the human power conveyed to the coupling shaft 231 (power with which the pedaling is performed) and the assist drive power of the electric motor 25 to the driving sprocket 34. The outer member 52 realizes a resultant force output shaft 235, which synthesizes the human power input via the one-way clutch 50 and the assist drive power input via the driven gear 233 and outputs the resultant force. The resultant force output shaft 235 is rotated coaxially with the pedal crankshaft 22. The resultant force output shaft 235 is included in the rotation shaft 23.

Now, a dust seal according to this example embodiment will be described.

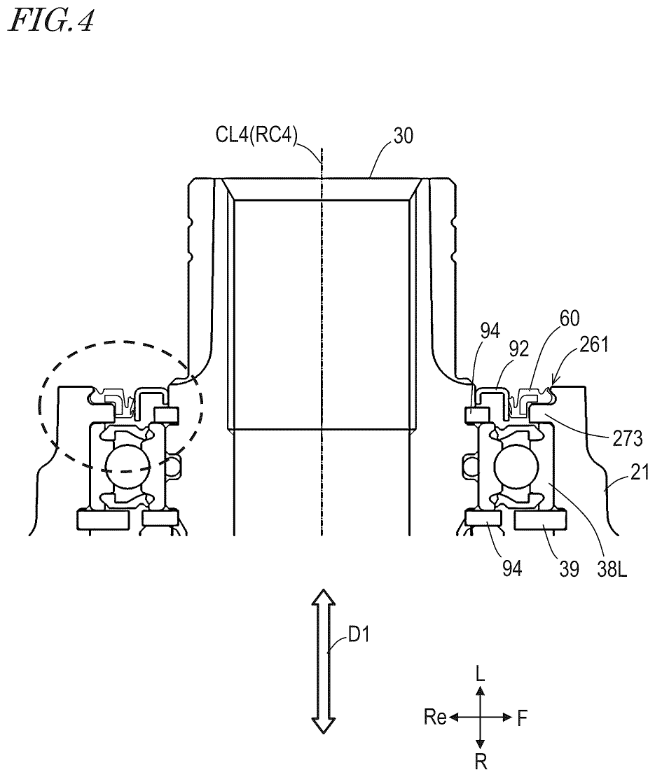

FIG. 4 is a cross-sectional view showing the opening 261 of the housing 21 and the rotatable shaft 30 extending through the opening 261.

The rotatable shaft 30 is rotatably supported by the housing 21 via the bearing 38L. An outer wheel of the bearing 38L is secured to the housing 21. The bearing 38L is prevented by a protrusion 273 of the housing 21 and snap rings 39 and 94 from moving in a rotation axis direction D1 of the rotatable shaft 30.

A ring-shaped dust seal 60 is located between the opening 261 of the housing 21 and the rotatable shaft 30. The dust seal 60 closes a gap between the opening 261 and the rotatable shaft 30 and reduces or prevents entrance of dust from the outside of the housing 21 into an inside of the housing 21.

In this example embodiment, the rotatable shaft 30 includes an adapter 92 to adjust a diameter of the pedal crankshaft 22. The adapter 92 is secured to the pedal crankshaft 22 by, for example, press-fit or serration coupling, and increases the diameter of a portion of the pedal crankshaft 22. The dust seal 60 is in slidable contact with the adapter 92 of the rotatable shaft 30. The dust seal 60 may be in direct contact with the pedal crankshaft 22 of the rotatable shaft 30.

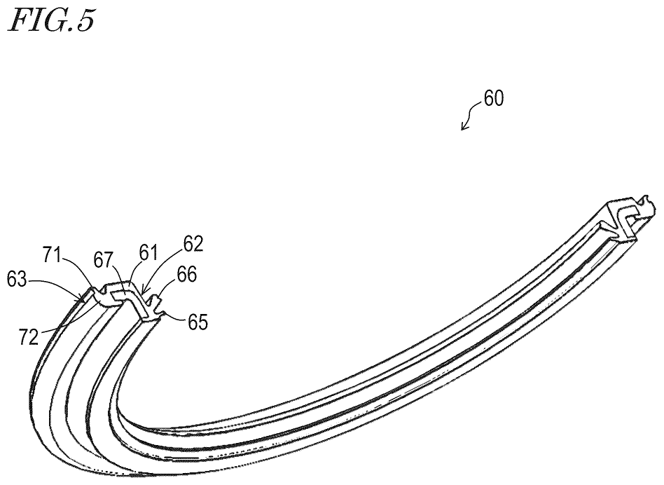

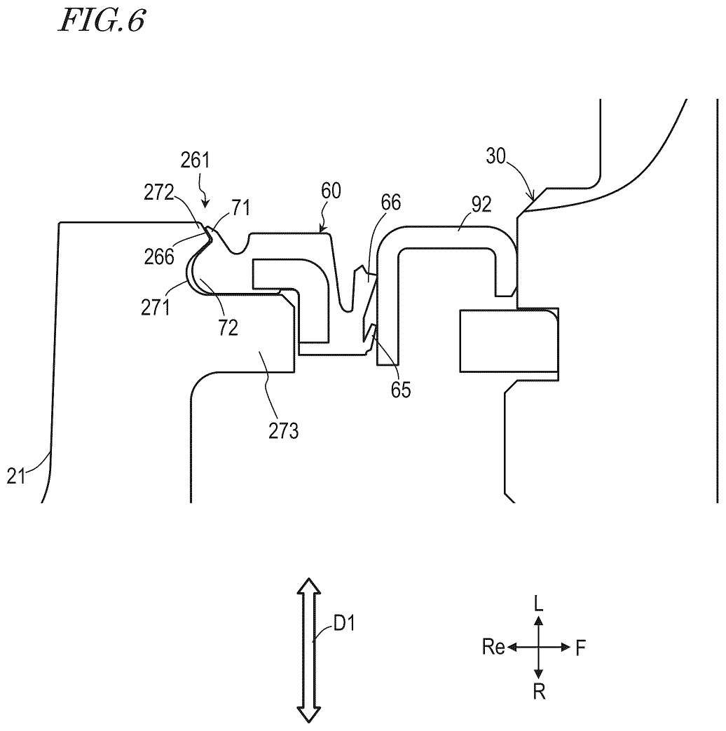

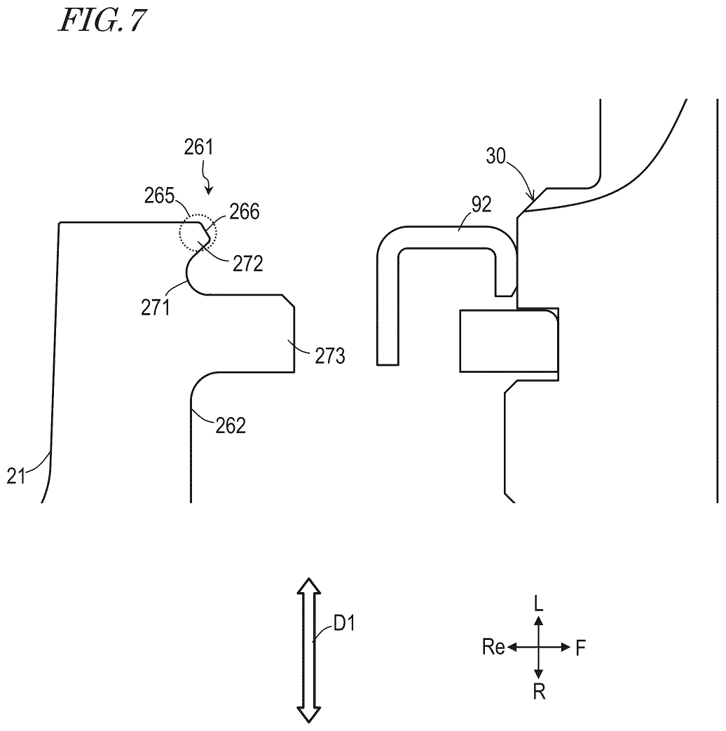

FIG. 5 is a perspective view showing the dust seal 60 cut along a plane parallel to the rotation axis direction D1 of the rotatable shaft 30. FIG. 6 and FIG. 7 are each a partial enlarged cross-sectional view of the drive unit 20, and show a region enclosed by the dashed line in FIG. 4 enlarged. FIG. 7 omits the dust seal 60. FIG. 6 and FIG. 7 omit the bearing 38L for easier understanding of a feature of this example embodiment. In the example shown in FIG. 4, FIG. 6 and FIG. 7, the left side in the rotation axis direction D1 of the rotatable shaft 30 is the outer side of the housing 21, and the right side in the rotation axis direction D1 is the inner side of the housing 21. The outer side of the housing 21 in the rotation axis direction D1 is the outer side of the opening 261.

As shown in FIG. 5, the dust seal 60 includes a body 61 and a metal ring (reinforcing ring) 67. The body 61 is made of, for example, an elastomer such as synthetic rubber or the like. The metal ring 67 increases the rigidity of the dust seal 60. A seal lip 65 and a dust lip 66 are provided in an inner circumferential portion 62 of the dust seal 60. A first lip 71 and a second lip 72 are provided in an outer circumferential portion 63 of the dust seal 60.

As shown in FIG. 6, the seal lip 65 and the dust lip 66 provided in the inner circumferential portion 62 of the dust seal 60 are in slidable contact with the adapter 92 of the rotatable shaft 30. The dust lip 66 is located outward of the seal lip 65 in the rotation axis direction D1. The seal lip 65 and the dust lip 66 reduce or prevent the flow of oil from the inside of the housing 21 to the outside of the housing 21, and also reduce or prevent the entrance of water and dust from the outside of the housing 21 into the inside of the housing 21.

The first lip 71 and the second lip 72 provided in the outer circumferential portion 63 of the dust seal 60 are in contact with an inner circumferential portion 262 of the opening 261 of the housing 21.

A groove 271 is provided in the inner circumferential portion 262 of the opening 261 in a circumferential direction of the opening 261. The inner circumferential portion 262 includes a protrusion 272 defining an outer wall of the groove 271 and the protrusion 273 defining an inner wall of the groove 271 in the rotation axis direction D1. The protrusion 272 and the protrusion 273 each extend generally toward the rotatable shaft 30 from the inner circumferential portion 262.

A second lip 72 of the dust seal 60 extends away from the rotatable shaft 30, and is fitted into the groove 271 of the inner circumferential portion 262 of the opening 261. In this example, the second lip 72 is fitted into the groove 271 by snap-fit. The second lip 72 is fitted into the groove 271 so that the dust seal 60 may be secured to the housing 21. In addition, the flow of oil from the inside of the housing 21 to the outside of the housing 21 may be reduced or prevented, and also the entrance of water and dust from the outside of the housing 21 into the inside of the housing 21 may be reduced or prevented.

An outer end 265, in the rotation axis direction D1, of the inner circumferential portion 262 of the opening 261 includes a chamfered portion 266, which is C-chamfered or R-chamfered. The chamfered portion 266 has a diameter increasing toward an outside of the opening 261. In this example embodiment, the chamfered portion 266 is provided at the protrusion 272.

The first lip 71 of the dust seal 60 extends away from the rotatable shaft 30 and outward in the rotation axis direction D1. As shown in FIG. 6, the first lip 71 covers the chamfered portion 266 of the opening 261. In this example embodiment, the expression “the first lip 71 covers the chamfered portion 266” may indicate that the first lip 71 covers a portion of the chamfered portion 266 or indicate that the first lip 71 covers the entirety of the chamfered portion 266.

In the case where the housing 21 and the rotatable shaft 30 include metal materials different from each other, when water accumulates between the opening 261 of the housing 21 and the rotatable shaft 30, electrolytic corrosion (galvanic corrosion) easily occurs. The electrolytic corrosion may be reduced to some extent by a paint applied to the opening 261. However, in the case where the opening 261 has a certain shape, the paint may not be applied to the opening 261 in a satisfactory manner. In the case where, for example, the protrusion 272 provided at the opening 261 is thin, the paint is not applied to the protrusion 272 in a satisfactory manner. According to this example embodiment, the dust seal 60 includes the first lip 71 covering the chamfered portion 266 of the opening 261. The first lip 71 covers the chamfered portion 266, so that the electrolytic corrosion may be reduced or prevented even when the paint is not applied to the opening 261 in a satisfactory manner.

The first lip 71 and the second lip 72 of the dust seal 60 hold or secure the protrusion 272 therebetween by an elastic force thereof. With this arrangement, a gap is unlikely between the first lip 71 and the chamfered portion 266, and thus the electrolytic corrosion may be reduced or prevented more effectively. In addition, the flow of oil from the inside to the outside of the housing 21 may be reduced or prevented more effectively, and the entrance of water and dust from the outside into the inside of the housing 21 may be reduced or prevented more effectively.

Now, the positional relationship between the opening 261 of the housing 21 and the dust seal 60 in the rotation axis direction D1 will be described.

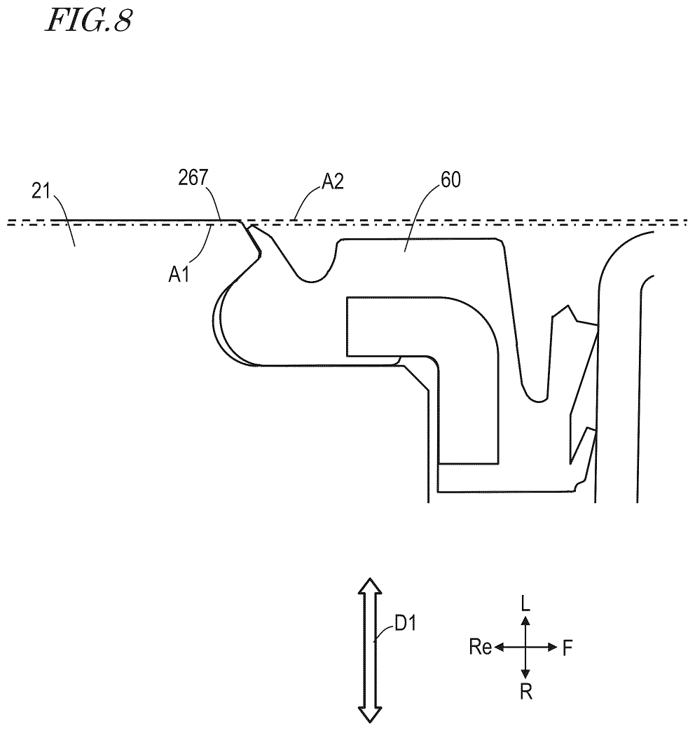

FIG. 8 is a cross-sectional view showing the positional relationship between the opening 261 of the housing 21 and the dust seal 60 in the rotation axis direction D1. In the example shown in FIG. 8, the left side in the rotation axis direction D1 is the outer side of the housing 21, and the right side in the rotation axis direction D1 is the inner side of the housing 21. In FIG. 8, a one-dot chain line A1 shows the outermost position, in the rotation axis direction D1, of the dust seal 60. In FIG. 8, a dashed line A2 shows an outermost portion 267 of the opening 261 of the housing 21.

In this example embodiment, the dust seal 60 does not protrude outward, in the rotation axis direction D1, of the outermost portion 267 of the opening 261. With this arrangement, the size of the drive unit 20 in the width direction (left-right direction) may be decreased.

Components such as the crankarms 35 and the like are attached to the rotatable shaft 30. If the dust seal 60 protrudes outward of the opening 261 of the housing 21, the dust seal 60 may interfere with the crankarms 35 or the like. Since the dust seal 60 does not protrude outward of the opening 261 in this example embodiment, the interference of the dust seal 60 with the crankarms 35 or the like may be reduced or prevented.

The first lip 71 of the dust seal 60 covers the chamfered portion 266 in such a range that does not allow the dust seal 60 to protrude outward of the outermost portion 267 of the opening 261. As long as the dust seal 60 does not protrude outward of the outermost portion 267 of the opening 261, the first lip 71 may cover the entirety of the chamfered portion 266.

In an above-described example, the dust seal 60 is secured to the inner circumferential portion 262 of the opening 261 by snap-fit. Alternatively, the dust seal 60 may be secured to the inner circumferential portion 262 by press-fit.

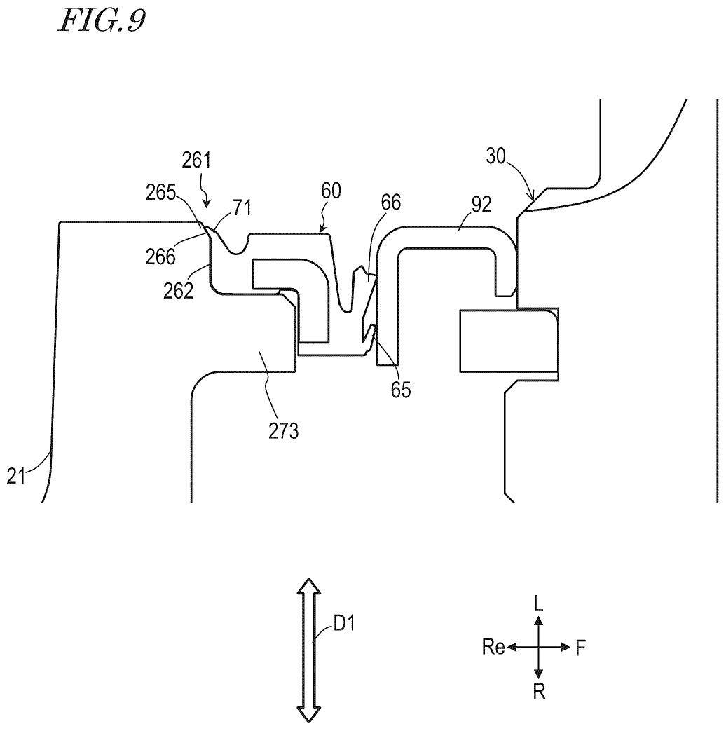

FIG. 9 is a cross-sectional view showing the dust seal 60 in a state of being secured to the inner circumferential portion 262 of the opening 261 by press-fit. In the example shown in FIG. 9, the groove 271 is not provided in the inner circumferential portion 262, and the dust seal 60 is secured to the inner circumferential portion 262 by press-fit.

The outer end 265, in the rotation axis direction D1, of the inner circumferential portion 262 includes the chamfered portion 266. The first lip 71 of the dust seal 60 covers the chamfered portion 266 of the opening 261. With this arrangement, the electrolytic corrosion may be reduced or prevented.

In an above-described example embodiment, the drive unit 20 (FIG. 2) includes four shafts, more specifically, the output shaft 2522, the conveyance shaft 243, the rotation shaft 43 and the rotatable shaft 30. The number of the shafts is not limited to four. The present invention is applicable to a drive unit including five or more shafts. For example, the present invention is applicable to a drive unit in which a gear is located between the output gear 252A of the electric motor 25 and the first conveyance gear 241 of the decelerator 24 and a torque is conveyed from the output gear 252A to the first conveyance gear 241 via such a gear.

In an above-described example embodiment, the drive unit 20 includes the idle gear 41. The present invention is applicable to the drive unit 20 without the idle gear 41.

In an above-described example embodiment, the entirety of the electric motor 25 is accommodated in the housing 21. The configuration of the housing 21 is not limited to this. Only a portion of the electric motor 25 may be accommodated in the housing 21. For example, an opening through which the electric motor 25 may extend is provided in a left portion of the first case 211, and the electric motor 25 may be attached such that the portion thereof is located inside the housing 21 through the opening. In this case, the opening may be covered with a cover to prevent the entrance of dust and water.

The cover 213 (FIG. 2) may be a portion of the housing 21 and may be included in the housing 21. The cover 213 may be shaped to cover a side surface of the electric motor 25, and the electric motor 25 may be supported by the cover 213. An example embodiment in which the electric motor 25 is supported by the cover 213 is encompassed in an example embodiment in which the electric motor 25 is supported by the housing 21.

In the above-described example embodiments, the present invention is applied to the electrically assisted bicycle 1, which is a two-wheeled vehicle. The present invention is not limited to this, and is applicable to a three-wheeled electrically assisted vehicle.

In the above-described example embodiments, the driving wheel to which the power of a human body generated by the rider stepping on the pedals and the assist power generated by the electric motor are conveyed is the rear wheel. The present invention is not limited to this. The power of the human body and the assist power may be conveyed to the front wheel, or may be conveyed to both of the front wheel and the rear wheel, in accordance with the type of the electrically assisted bicycle. The present invention may be applied to an electrically assisted bicycle including a hub motor provided on the front wheel.

Illustrative example embodiments of the present invention are described above. This specification discloses drive units and electrically assisted bicycles as described below.

A drive unit 20 for an electrically assisted bicycle 1 includes an electric motor 25, a housing 21 to accommodate the electric motor 25, a rotatable shaft 30 rotatably supported by the housing 21 and partially exposed to an outside of the housing 21, and a ring-shaped dust seal 60 provided between the rotatable shaft 30 and the housing 21 to prevent entrance of dust from the outside the housing 21 into an inside of the housing 21, wherein the housing 21 and the rotatable shaft 30 include metal materials different from each other, an inner circumferential portion 62 of the dust seal 60 is in slidable contact with the rotatable shaft 30, an outer circumferential portion 63 of the dust seal 60 is in contact with an inner circumferential portion 262 of an opening 261 of the housing 21 to allow the rotatable shaft 30 to extend therethrough, an outer end 265, in a rotation axis direction D1 of the rotatable shaft 30, of the inner circumferential portion 262 of the opening 261 of the housing 21 includes a chamfered portion 266 having a diameter increasing toward an outside of the opening 261, the dust seal 60 includes a first lip 71 covering the chamfered portion 266, and the dust seal 60 does not protrude outward, in the rotation axis direction D1, of an outermost portion 267 of the opening 261 in the rotation axis direction D1.

In the case where the housing 21 and the rotatable shaft 30 include metal materials different from each other, when water accumulates between the opening 261 of the housing 21 and the rotatable shaft 30, electrolytic corrosion (galvanic corrosion) easily occurs. The electrolytic corrosion may be reduced to some extent by a paint applied to the opening 261. However, there are cases where the paint is not applied to the opening 261 in a satisfactory manner. In the case where, for example, the protrusion 272 provided at the opening 261 is thin, the paint is not applied to the protrusion 272 in a satisfactory manner. According to an example embodiment of the present invention, the dust seal 60 includes the first lip 71 covering the chamfered portion 266 of the opening 261. The first lip 71 covers the chamfered portion 266 so that the electrolytic corrosion may be reduced or prevented even when the paint is not applied to the opening 261 in a satisfactory manner.

According to an example embodiment of the present invention, the dust seal 60 does not protrude outward, in the rotation axis direction D1, of the outermost portion 267 of the opening 261. With this arrangement, the size of the drive unit 20 in the width direction may be decreased.

The crankarms 35 may be attached to the rotatable shaft 30. If the dust seal 60 protrudes outward of the opening 261 of the housing 21, the dust seal 60 may interfere with the crankarms 35 or the like. Since the dust seal 60 does not protrude outward of the opening 261 in this example embodiment, the interference of the dust seal 60 with the crankarms 35 is reduced or prevented.

In the drive unit 20 above, the first lip 71 of the dust seal 60 extends away from the rotatable shaft 30 and outward in the rotation axis direction D1.

With this arrangement, the chamfered portion 266 of the opening 261 may be covered appropriately.

In the drive unit 20 above, the inner circumferential portion 262 of the opening 261 includes a groove 271 extending in a circumferential direction of the opening 261, and the outer circumferential portion 63 of the dust seal 60 includes a second lip 72 fitted into the groove 271.

Since the second lip 72 of the dust seal 60 is fitted into the groove 271 of the opening 261, the dust seal 60 may be secured to the housing 21.

In the drive unit 20 above, the opening 261 includes a protrusion 272 defining an outer wall of the groove 271 in the rotation axis direction D1, and the chamfered portion 266 is provided at the protrusion 272.

Even when paint is not applied to the opening 261 in a satisfactory manner, the first lip 71 covers the chamfered portion 266 and thus the electrolytic corrosion is reduced or prevented.

In the drive unit 20 above, the second lip 72 of the dust seal 60 is snap-fit into the groove 271.

The dust seal 60 may be secured to the housing 21 by snap-fit. In addition, the entrance of water and dust into the inside of the housing 21 may be reduced or prevented more effectively.

In the drive unit 20 above, the first lip 71 and the second lip 72 of the dust seal 60 secure the protrusion 272 therebetween by an elastic force thereof.

With this arrangement, a gap is unlikely between the first lip 71 and the chamfered portion 266, and thus the electrolytic corrosion is reduced or prevented more effectively. In addition, the entrance of water and dust into the inside of the housing 21 may be reduced or prevented more effectively.

In the drive unit 20 above, the dust seal 60 is press-fit into the opening 261.

The dust seal 60 is press-fitted to the opening 261, and therefore, may be secured to the housing 21.

In the drive unit 20 above, the inner circumferential portion 62 of the dust seal 60 includes a seal lip 65 in slidable contact with the rotatable shaft 30.

With this arrangement, the flow of oil from the inside to the outside of the housing 21 and the entrance of water and dust from the outside into the inside of the housing 21 may be reduced or prevented.

In the drive unit 20 above, the inner circumferential portion 62 of the dust seal 60 further includes a dust lip 66 in slidable contact with the rotatable shaft 30 and located outward of the seal lip 65 in the rotation axis direction D1.

With this arrangement, the entrance of dust from the outside into the inside of the housing 21 may be reduced or prevented.

In the drive unit 20 above, the housing 21 includes a metal material including magnesium as a main component.

With this arrangement, the weight of the drive unit 20 may be decreased.

In the drive unit above, the rotatable shaft 30 includes a metal material including iron as a main component.

With this arrangement, a level of rigidity and strength that is required of the rotatable shaft 30 may be realized at low cost.

An electrically assisted bicycle 1 includes the drive unit 20 as described above.

With this arrangement, the electrically assisted bicycle 1 including the drive unit 20 that is compact and highly resistant to water may be realized.

Example embodiments of the present invention are especially useful in the field of electrically assisted bicycles.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A drive unit for an electrically assisted bicycle, the drive unit comprising:
an electric motor;
a housing to accommodate the electric motor;
a rotatable shaft rotatably supported by the housing and partially exposed to an outside of the housing; and
a ring-shaped dust seal between the rotatable shaft and the housing to prevent entrance of dust from outside the housing into an inside of the housing; wherein
the housing and the rotatable shaft include metal materials different from each other;
an inner circumferential portion of the dust seal is in slidable contact with the rotatable shaft;
an outer circumferential portion of the dust seal is in contact with an inner circumferential portion of an opening of the housing to allow the rotatable shaft to extend therethrough;
an outer end, in a rotation axis direction of the rotatable shaft, of the inner circumferential portion of the opening of the housing includes a chamfered portion having a diameter increasing toward an outside of the opening;
the dust seal includes a first lip covering the chamfered portion; and
the dust seal does not protrude outward, in the rotation axis direction, of an outermost portion of the opening in the rotation axis direction.

2. The drive unit of claim 1, wherein the first lip of the dust seal extends away from the rotatable shaft and outward in the rotation axis direction.

3. The drive unit of claim 1, wherein
the inner circumferential portion of the opening includes a groove extending in a circumferential direction of the opening; and
the outer circumferential portion of the dust seal includes a second lip fitted into the groove.

4. The drive unit of claim 3, wherein
the opening includes a protrusion defining an outer wall of the groove in the rotation axis direction; and
the chamfered portion is provided at the protrusion.

5. The drive unit of claim 3, wherein the second lip of the dust seal is snap-fit into the groove.

6. The drive unit of claim 4, wherein the first lip and the second lip of the dust seal secure the protrusion therebetween by an elastic force thereof.

7. The drive unit of claim 1, wherein the dust seal is press-fit into the opening.

8. The drive unit of claim 1, wherein the inner circumferential portion of the dust seal includes a seal lip in slidable contact with the rotatable shaft.

9. The drive unit of claim 8, wherein the inner circumferential portion of the dust seal further includes a dust lip in slidable contact with the rotatable shaft and located outward of the seal lip in the rotation axis direction.

10. The drive unit of claim 1, wherein the housing includes a metal material including magnesium as a main component.

11. The drive unit of claim 10, wherein the rotatable shaft includes a metal material including iron as a main component.

12. An electrically assisted bicycle comprising:
the drive unit of claim 1.
